(19) United States
(12) Patent Application Publication
(10) Pub. No.: US 2014/0220280 A1
(43) Pub. Date: Aug. 7, 2014

(54) PROCESS OF RECYCLING PLASTICS, PRODUCTS AND APPLICATIONS THEREOF

(71) Applicants: Natarasan Sethu, Mumbai (IN); Chandrashekhar Ramchandra Abhyankan, Mumbai (IN); Mrinal Kanti Banerjee, Mumbai (IN)

(72) Inventors: Natarasan Sethu, Mumbai (IN); Chandrashekhar Ramchandra Abhyankan, Mumbai (IN); Mrinal Kanti Banerjee, Mumbai (IN)

(73) Assignee: ESSEL PROPACK LTD., Mumbai (IN)

(21) Appl. No.: 14/127,677

(22) PCT Filed: Jun. 19, 2012
(86) PCT No.: PCT/IN2012/000436

§ 371 Date: Apr. 4, 2014

(30) Foreign Application Priority Data
Jun. 20, 2011 (IN) 1791/MUM/2011

(51) Int. Cl. C08J 11/06

(52) U.S. Cl. CPC C08J 11/06
USPC 428/36.9; 428/35.7; 521/40; 521/47; 521/46.5; 528/308.2; 526/352; 526/352.2; 526/344; 526/351; 526/346

(57) ABSTRACT

The present disclosure relates to a process for recycling of plastic waste comprising: segregating plastic waste collected from various sources followed by cleaning of the segregated plastic waste to obtain segregated cleaned waste; grinding of the segregated cleaned waste to obtain grinded waste; introducing the grinded waste into an extrusion line having a venting extruder component as part of the extrusion line, to obtain molten plastic; and removing the impurities by vacuum venting of the molten plastic to obtained recycled plastic free from impurities.

The present disclosure further relates to various articles like Industrial Post Recycled (IPR) plastic tubes, blow moulded bottles, pallates, manufactured from the recycled plastic waste.

### TECHNICAL FIELD

The present disclosure relates to a process for recycling of plastic waste, by which useless plastic waste can be transformed into a useful resource. The present disclosure further relates to applications of such recycled plastics.

### BACKGROUND

The tube packaging industry is accelerating speedily because of constant increase in number of products using plastic tubes for packaging. Plastics are derived from petroleum sources and are generally non-biodegradable. The unprecedented use of plastic tubes has made them a major component of solid, non-environment friendly waste coming out from industries as well as consumers. Most of the post industrial or post consumer use plastic tubes waste goes to landfill sites adding to serious environmental problems, like land, water, and air pollution. In addition, the disposal costs for the post industrial plastic waste poses an extra burden on the tube processors/manufacturers.

The traditional processes for extrusion of recycled plastic material involve a number of significant and costly pre-process steps like segregating and beading. The commercial viability of these processes is challenged when the extrusion process and the product thereof the recycled material is not of a quality as of a virgin material. The recycling processes presently faces problems of uneven flow of material on the extrusion line due to presence of contaminants and impurities like, printing remains, varnishes, colors, different material compositions, left out contents, and moisture etc. in post industrial or post consumer use plastic tubes.

U.S. Pat. No. 5,780,696 discloses a process of recycling of plastic waste, in particular waste rich in polyvinyl chloride (PVC) plastics, and which makes it possible to recover a maximum amount of reusable product. This process converts a large amount of plastics into a solid product with low chlorine content. US Patent application No. US 2007/0149625 A1 discloses a process and an apparatus for the recycling of waste plastics found in municipal solids waste. It also discloses a process for recycling plastic material by providing a common dielectric property to the plastic material and treating the plastic material using microwave energy.

There is a need to develop a processing technique to remove both volatile and non-volatile contaminants which can provide high quality plastic material from recycled plastic and can be used as a substitute of virgin material. The improved recycling process should reduce/reuse waste, should be economical, energy efficient, reduce carbon footprint, help in environmental protection and deliver a new end-product with high technical features.

Given the above stated problems and an environmentally aware society, processors have the opportunity and incentives to adopt new green technologies for reducing and reusing waste. It is to this need that the present subject matter is directed.

### SUMMARY

The present disclosure relates to a process for recycling of plastic waste.

In an aspect of the present disclosure, it provides a process for process for recycling of plastic waste comprising: segregating plastic waste collected from various sources followed by cleaning of the segregated plastic waste to obtain segregated cleaned waste; grinding of the segregated cleaned waste to obtain grinded waste; introducing the grinded waste into an extrusion line having a venting extruder component as part of the extrusion line, to obtain molten plastic; and removing the impurities by vacuum venting of the molten plastic to obtained recycled plastic free from impurities.

The present disclosure further relates to an article like Industrial Post Recycled (IPR) plastic tubes, blow moulded bottles, and pallates, manufactured from the recycled plastic waste.

These and other features, aspects, and advantages of the present subject matter will become better understood with reference to the following description. This statement is provided to introduce a selection of concepts in a simplified form. This statement is not intended to identify key features or essential features of the subject matter, nor is it intended to be used to limit the scope of the subject matter.

### BRIEF DESCRIPTION OF DRAWINGS

The above and other features, aspects, and advantages of the subject matter will be better understood with regard to the following description, appended claims, and accompanying drawings where:

FIG. 1 illustrates a method of recycling of plastic scrap to obtain recycled plastic materials, according to an embodiment of the present subject matter.

### DETAILED DESCRIPTION

The present disclosure provides a process for recycling of plastic waste, from waste sources such as processors, manufacturers or consumers.

In one aspect, an embodiment of the present disclosure provides a process for process for recycling of plastic waste comprising: segregating plastic waste collected from various sources followed by cleaning of the segregated plastic waste to obtain segregated cleaned waste; grinding of the segregated cleaned waste to obtain grinded waste; introducing the grinded waste into an extrusion line having a venting extruder component as part of the extrusion line, to obtain molten plastic; and removing the impurities by vacuum venting of the molten plastic to obtained recycled plastic free from impurities.

In an embodiment, the present disclosure provides a process for recycling of plastic waste comprising: segregating plastic waste collected from various sources followed by cleaning of the segregated plastic waste to obtain segregated cleaned waste; grinding of the segregated cleaned waste to obtain grinded waste; introducing the grinded waste into an extrusion line having a venting extruder component as part of the extrusion line, to obtain molten plastic; removing the impurities by vacuum venting of the molten plastic to obtained recycled plastic free from impurities; obtaining the recycled plastic free from impurities as long hollow strands of molten plastic with uniform diameter; and cooling the strands and cutting to pellet forms of recycled plastic material.

In another embodiment, the plastics waste used for the recycling process of the present disclosure is collected from source selected from running plastic tubing operation, post industrial used plastics, or post consumer used plastics.

The post industrial plastic waste required for recycling of plastic waste originates from original equipment manufacturers, processors, and assemblers.

The plastic waste variably contains resins such as polyethylene terephthalate (PET); high density polyethylene (HDPE); polyvinyl chloride (PVC); low density polyethylene (LDPE); polypropylene (PP); or polystyrene (PS).

The recycling process involves identification and segregation of the plastic waste into groups of similar properties or types including, but not limited to, linear low density polymers, low density polymers, or high density polymer varieties. The waste can further be sub classified into plain, color, printed, non-printed, foil stamped tubes; caps enclosures, metalized polypropylene wastes; shoulder; extruded pipe wastage; lumps; and purged material wastes etc. There can also be sub-groups for this segregation depending on the type of end-use of the plastic, color, types of printing and inks used, type of polymer used etc. A recycling process suitable for a particular type of a polymer is selected for better recycling results. The segregated waste is bagged and tagged separately.

Further, the segregated plastic waste is cleaned separately. The cleaning of waste plastic is done by a combination of washing processes. One type of washing is by pouring waste in a water tank with plastic waste and lifting after some time, leaving behind hard impurities like dirt in the tank. Further an embodiment of the present disclosure, the cleaning of the segregated plastic waste is by a plurality of washing with water and having about 2% caustic soda. This facilitates loosing and leaving of sticky materials from the collected plastic waste. Furthermore, the plastic waste is kept under running water which will clean remaining impurities from the plastic waste. The material is then dried by any conventional method, like shadow drying or other non-conventional method, like electric driers.

After the plastic waste is cleaned, it is size-reduced/ grinded via general known methods. In an embodiment, the grinding of the segregated cleaned waste is done using scrap grinder, agglomerator, shredder, granulator. The scrap grinders are used to chop and powder the hard materials in the plastic waste like shoulders, caps and closures waste as segregated earlier and the agglomerator is used to chop the sleeve part of the plastic waste. Agglomeration process is a non-heating arrangement thus causing minimum thermo-degradable damage, where the plastic waste is heated up with frictional heat only and no additional heat is supplied to the system. The plastic material is cut by rotating sigma blades and collected in a try. If lumps are present in the output then they are resend for agglomeration. The fine beads of the plastic waste material are obtained as the output of this process.

This is followed by entering of the material to an extrusion line in which the plastic waste in form of beads enters through the hopper feed and comes into contact with a rotating screw. The extrusion line is added with a venting extruder component by which the molten plastic with impurities is vacuum vented. The process removes impurities and generates an improved quality plastic polymer, which can be further processed as desired. The rotating screw in a barrel forces the plastic waste beads further into the barrel which is heated to a desired melt temperature of the plastic. The plastic beads melt gradually. Some extra heat is also generated by the pressure and friction inside the barrel. A venting extruder is a two-stage screw extruder having an opening part way along the barrel for the removal of air and volatile matter from the plastics material. The venting extruder is equipped with one or more openings (vent ports) in the extruder barrel, through which volatiles can escape. Thus, the vented extruder can extract volatiles from the polymer in a continuous fashion.

A simple plastic extrusion screw has different zones like: a feed zone or conveyer, which feeds the resin into the extruder with same channel depth; a melting zone or compressor, in which most of the resin is melted and the channel depth gets smaller and smaller; a metering zone, which melts the remaining particles and mixes to a uniform temperature and composition with same channel depth.

Any irregular flow of molten plastic of the plastic waste at any stage would produce a product with unwanted strain at certain points in the final product. These strains can cause distortions upon cooling. The distortions can deform the shape, color, or quality of the output plastic. Hence, the molten plastic is required to be free from any distortions. An embodiment of the present disclosure, the extrusion line comprises of a venting extruder component, preferably a see-through venting extruder, by which the molten plastic with impurities is vacuum vented, thereby relieving the pressure and allowing any trapped gases (usually moisture or air) to be drawn out by vacuum. The process removes all volatile impurities and generates an improved quality plastic polymer which can be further processed as desired. The output from the venting screw has minimum moisture level and is also free of contaminants such as inks and varnish. The un-vented output otherwise contains gaseous part and chokes up causing problem to conveyor.

The present disclosure is further directed to a process of removal of undesired contaminants/impurities from a molten plastic flowing through an extrusion line, wherein these contaminants including volatile substances are vented out in vacuum.

The molten plastic goes to an auto screen change over pack assembly which serves to create back pressure in the barrel; back pressure is required for uniform melting and proper mixing of the plastic waste. The auto screen is fitted between the end flange of the extruder and the die. The auto screen moves across the flow of molten plastic and a fresh screen enters as a spent filter screen exits, removing the impurities from the extrudate. The pure molten plastic obtained enters a die which will give a desired shape of the needed product.

In one embodiment, long hollow strands of molten plastic with uniform diameter are obtained and are cooled, generally by a water bath. The strands are cut into desired size pellets and are segregated by a vibrator. The pellets of controlled sizes are collected and bagged in granule form.

In yet another embodiment, the pellet granules are tested for tensile strengths, elongation properties, color shades, ink acceptability and other properties.

Another embodiment of the present subject matter further provides articles made of the recycled plastic polymer pellet granules of the present subject matter. The high quality recycled pellet granules are used to make plastic tubes that have improved quality than the conventional recycled tubes. The manufactured plastic tubes can be used in various tube packaging applications, for example, shoe polish, oil applications, hand wash, face wash, etc. The process for recycling of plastic waste helps in environment protection is eco-friendly and reduces the carbon footprint.

The present disclosure further provide a simple and an economical process for separating post industrial and post consumer plastic tubes into groupings based on a selected coding/identification system. The present disclosure can be used to purify a number of polymers that may conveniently work in an extruder operating environment. As stated, the disclosed process is particularly suited to recover recycled purified plastic from scrap of post industrial used plastics. In an embodiment, an article can be made of the recycled plastic material. In another embodiment, the article made of the recycled plastic material is an industrial post recycled (IPR) plastic tube, Blow moulded Bottles, and Pallates.

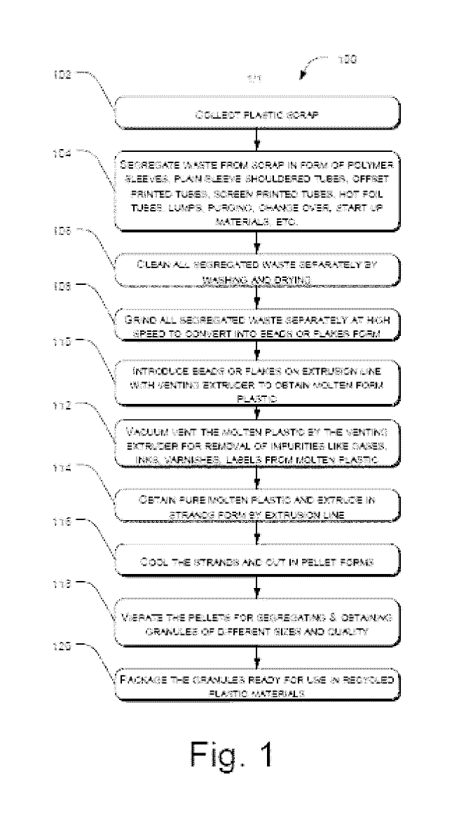

In an embodiment, FIG. 1 is an exemplary presentation of a manufacturing process 100 of extrusion ready purified plastic granules for use in recycled plastic materials of the present disclosure. The process 100 involves collecting plastic scrap 102 from various sources including, but not limited to, running plastic tubing operations, post consumer wastes, post industrial wastes. At block 104, the process 100 involves segregating waste from the collected plastic scrap in form of polymer sleeves, plain sleeve shouldered tubes, offset printed tubes, screen printed tubes, hot foil tubes, lumps, purging, change over, start up materials, etc. Further, cleaning of the segregated waste is done at block 106 which includes washing and drying by traditional methods. The grinding of all segregated cleaned waste is done at 108 separately with a high speed grinder such as scrap grinder, agglomerator, shredder, granulator, etc. The grinding process converts the segregated waste into fine beads or flakes of uniform sizes. The block 110 introduces beads or flakes into an extrusion line having a venting extruder as part of the extrusion line. The extrusion line melts the beads and converts it into molten plastic material. As this stage the molten plastic may have some impurities. The vacuum venting of molten plastic happens at block 112 where the venting extruder of the extrusion line will vent and remove the impurities like gases, inks, varnishes, labels from the molten plastic. In one embodiment, the venting extruder can be a see-through venting extruder. Further, after vacuum venting the molten plastic free from impurities is obtained at block 114, the extruding of this molten plastic happens in extrusion line and long thin strands of the molten plastic are obtained as output of block 114. At block 116, the cooling of strands is done with help of water bed or any other generally known methods. After cooling, strands at cut into pellet forms. Segregating the pellets by vibrating the pellets happens at block 118 where granules of different sizes and quality are obtained as output of vibration. At block 120, packaging of the granules is done for further use in making plastic material of recycled purified granules.

In a preferred embodiment, the above process involves obtaining refined, purified granules 120 from the plastic scrap using the process 100. The granules obtained can be used to manufacture various articles. Non-limiting examples of such articles are Industrial Post Recycled (IPR) plastic tubes, Blow moulded Bottles, Pallates, etc.

The previously described versions of the subject matter and its equivalent thereof have many advantages, including those which are described below:
1. The subject matter provides high quality recycled plastic that has good tensile strength and other technical features.
2. The subject matter enhances the eco-friendliness of the process.
3. The recycled plastic can be used in a number of applications.
4. The carbon footprint of the industry is reduced.
5. The cost of disposing off the post industrial use waste is saved.
6. Revenue generation by reuse of the post-industrial waste.
7. Land, air, and water pollution is reduced due to reduction in land filling of plastic waste.

Although the subject matter has been described in considerable detail with reference to certain preferred embodiments thereof, other embodiments are possible. As such, the spirit and scope of the subject matter should not be limited to the description of the preferred embodiment contained therein.

1. A process for recycling of plastic waste comprising:
segregating plastic waste collected from various sources followed by cleaning of the segregated plastic waste to obtain segregated cleaned waste;
grinding of the segregated cleaned waste to obtain grinded waste;
introducing the grinded waste into an extrusion line having a venting extruder component as part of the extrusion line, to obtain molten plastic; and
removing the impurities by vacuum venting of the molten plastic to obtained recycled plastic free from impurities.

2. The process as claimed in claim 1 further comprising:
obtaining the recycled plastic free from impurities as long hollow strands of molten plastic with uniform diameter; and
cooling the strands and cutting to pellet forms of recycled plastic material.

3. The process as claimed in claim 1, wherein the plastic waste is collected from source selected from running plastic tubing operation, post industrial used plastics, or post consumer used plastics.

4. The process as claimed in claim 1, wherein the plastic scrap contains resins selected from polyethylene terephthalate (PET), high density polyethylene (HDPE), polyvinyl chloride (PVC), low density polyethylene (LDPE), polypropylene (PP), or polystyrene (PS).

5. The process as claimed in claim 1, wherein the cleaning of the segregated plastic waste is by a plurality of washing with water and water having about 2% caustic soda.

6. The process as claimed in claim 1, wherein the grinding of the segregated cleaned waste is by using scrap grinder, agglomerator, shredder, or granulator.

7. The process as claimed in claim 1, wherein the venting extruder component is see-through.

8. An article made of the recycled plastic material as claimed in claim 1.

9. The article as claimed in claim 8, wherein the article is an industrial post recycled (IPR) plastic tube, Blow moulded Bottles, and Pallates.

10. The process as claimed in claim 2, wherein the plastic waste is collected from source selected from running plastic tubing operation, post industrial used plastics, or post consumer used plastics

11. The process as claimed in claim 2, wherein the plastic scrap contains resins selected from polyethylene terephthalate (PET), high density polyethylene (HDPE), polyvinyl chloride (PVC), low density polyethylene (LDPE), polypropylene (PP), or polystyrene (PS).
